(19) United States
(12) Patent Application Publication
(10) Pub. No.: US 2014/0040774 A1
(43) Pub. Date: Feb. 6, 2014

(54) SHARING PHOTOS IN A SOCIAL NETWORK SYSTEM

(71) Applicants: Tomasz Charytoniuk, San Francisco, CA (US); Anton Lopyrev, San Francisco, CA (US)

(72) Inventors: Tomasz Charytoniuk, San Francisco, CA (US); Anton Lopyrev, San Francisco, CA (US)

(73) Assignee: GOOGLE INC., Mountain View, CA (US)

(21) Appl. No.: 13/564,708

(22) Filed: Aug. 1, 2012

(51) Int. Cl. G06F 3/048; G06F 15/16

(52) U.S. Cl. 715/753

(57) ABSTRACT

Embodiments generally relate to sharing photos in a social network system. In one embodiment, a method includes determining a geographic location associated with each photo of a plurality of photos associated with a user. The method also includes providing a geographic map to the user, where each photo is displayed on the geographic map based on the geographic location of each photo. The method also includes enabling the user to select photos to share based on interaction with the geographic map.

### TECHNICAL FIELD

Embodiments relate generally to social networks, and more particularly to sharing photos in a social network system.

### BACKGROUND

Social network systems often enable users to share photos with each other. For example, users can share photos with friends and family, which provides enjoyable and bonding experiences among users in social networks. A user can create a photo album that is associated with the user's profile. The user can add photos to the photo album and organize the photos in the photo album. As owner of the photo album, the user can then allow other users to view the photos in the photo album.

### SUMMARY

Embodiments generally relate to sharing photos in a social network system. In one embodiment, a method includes determining a geographic location associated with each photo of a plurality of photos associated with a user. The method also includes providing a geographic map to the user, where each photo is displayed on the geographic map based on the geographic location of each photo. The method also includes enabling the user to select one or more photos to share based on interaction with the geographic map.

With further regard to the method, in one embodiment, the method also includes accessing a digital media stream, where the digital media stream includes the plurality of photos. The method also includes collecting geographic metadata associated with each photo, and determining each geographic location based on the respective geographic metadata. In one embodiment, each geographic location represents a location at which each respective photo was taken. In one embodiment, the method also includes enabling the user to select the photos to share based on their respective geographic locations. In one embodiment, the enabling of the user to select photos includes enabling the user to select one or more photos displayed on the geographic map. In one embodiment, the enabling of the user to select photos includes enabling the user to select at least one photo displayed on the geographic map, and enabling the user to indicate at least a second photo to be shared based on at least one attribute relative to the at least one photo. In one embodiment, the method also includes enabling the user to select photos to share based at least in part on one or more attributes. In one embodiment, the method also includes assigning a user-selected viewing privilege to the selected one or more photos.

In another embodiment, a method includes accessing a plurality of photos associated with a user, and determining a geographic location associated with each photo of the plurality of photos. Each geographic location represents a location at which each respective photo was taken. In one embodiment, the determining of each geographic location includes collecting geographic metadata associated with each photo, and determining each geographic location based on the respective geographic metadata. The method also includes providing a geographic map to the user, where each photo is displayed on the geographic map based on the geographic location of each photo. The method also includes enabling the user to select one or more photos to share based on interaction with the geographic map. The method also includes assigning a user-selected viewing privilege to the selected one or more photos.

In another embodiment, a system includes one or more processors, and logic encoded in one or more tangible media for execution by the one or more processors. When executed, the logic is operable to perform operations including: determining a geographic location associated with each photo of a plurality of photos associated with a user; providing a geographic map to the user, where each photo is displayed on the geographic map based on the geographic location of each photo; and enabling the user to select one or more photos to share based on interaction with the geographic map.

With further regard to the system, in one embodiment, the logic when executed is further operable to perform operations including accessing a digital media stream, where the digital media stream includes the plurality of photos. The logic when executed is further operable to perform operations including collecting geographic metadata associated with each photo, and determining each geographic location based on the respective geographic metadata. In one embodiment, each geographic location represents a location at which each respective photo was taken. In one embodiment, the logic when executed is further operable to perform operations including enabling the user to select the photos to share based on their respective geographic locations. In one embodiment, the enabling of the user to select photos includes enabling the user to select one or more photos displayed on the geographic map. In one embodiment, the enabling of the user to select photos includes enabling the user to select at least one photo displayed on the geographic map, and enabling the user to indicate at least a second photo to be shared based on at least one attribute relative to the at least one photo. In one embodiment, the logic when executed is further operable to perform operations including enabling the user to select photos to share based at least in part on one or more attributes.

### BRIEF DESCRIPTION OF THE DRAWINGS

FIG. 1 illustrates a block diagram of an example network environment, which may be used to implement the embodiments described herein.

FIG. 2 illustrates an example simplified flow diagram for sharing photos in a social network system, according to one embodiment.

FIG. 3 illustrates an example simplified graphical user interface (GUI) that includes a geographic map, according to one embodiment.

FIG. 4 illustrates a block diagram of an example server device, which may be used to implements the embodiments and methods described herein.

### DETAILED DESCRIPTION

Embodiments described herein generally relate to sharing photos in a social network system. In various embodiments, a method includes determining a geographic location associated with each photo of a group of photos associated with a user. For a given photo, a system may determine a geographic location based on collected geographic metadata, which may include, for example, geo-coordinate data (e.g., geo-coding) or other tagging indicia related to a geographic location.

The method also includes providing a digital image of a geographic map to the user, where each photo is displayed on the geographic map based on the geographic location of each photo. For example, the system may display a photo taken of a particular historical monument at the appropriate location of the historical monument on the geographic map. This provides a visual organization of the photos that corresponds to the geographic locations visited by the user (e.g., where the photos were taken).

The method also includes enabling the user to select photos to share based on the user's interaction with the geographic map. For example, the system may enable the user to use a pointer to select one or more photos, and then indicate which individuals or groups of people to send or provide access to such selected photos.

As described in more detail below, embodiments described herein increase overall engagement among users in a social networking environment by facilitating an increased percentage of photos that are shared with other users of the social network system.

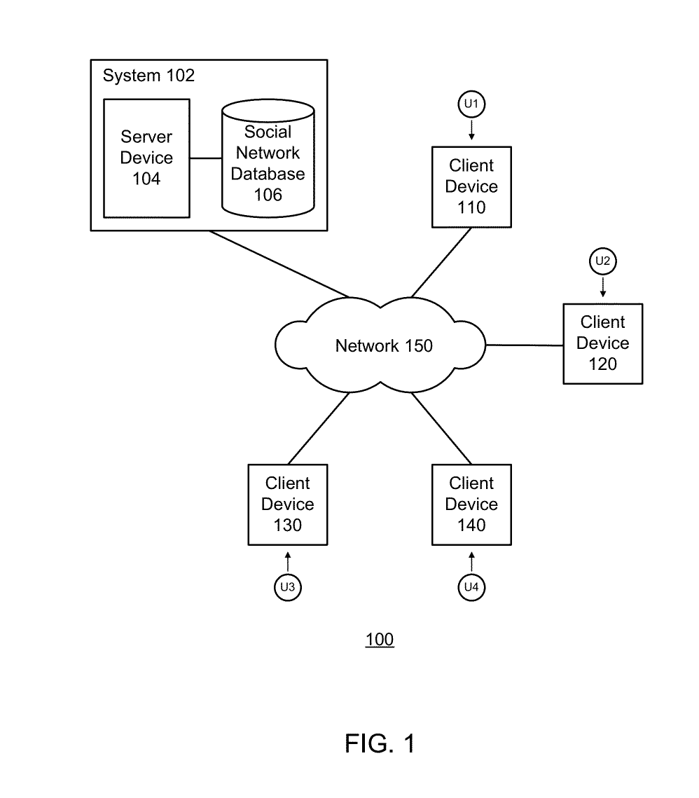

FIG. 1 illustrates a block diagram of an example network environment 100, which may be used to implement the embodiments described herein. In one embodiment, network environment 100 includes a system 102, which includes a server device 104 and a social network database 106. The term system 102 and phrase “social network system” may be used interchangeably. Network environment 100 also includes client devices 110, 120, 130, and 140, which may communicate with each other via system 102 and a network 150.

For ease of illustration, FIG. 1 shows one block for each of system 102, server device 104, and social network database 106, and shows four blocks for client devices 110, 120, 130, and 140. Blocks 102, 104, and 106 may represent multiple systems, server devices, and social network databases. Also, there may be any number of client devices. In other embodiments, network environment 100 may not have all of the components shown and/or may have other elements including other types of elements instead of, or in addition to, those shown herein.

In various embodiments, users U1, U2, U3, and U4 may communicate with each other and share media such as photos using respective client devices 110, 120, 130, and 140. For example, user U1 may take multiple photos, which may be uploaded to the social network system. User U1 may then share one or more of the photos with one or more other users (e.g., users U2, U3, and U4) based on the embodiments described herein.

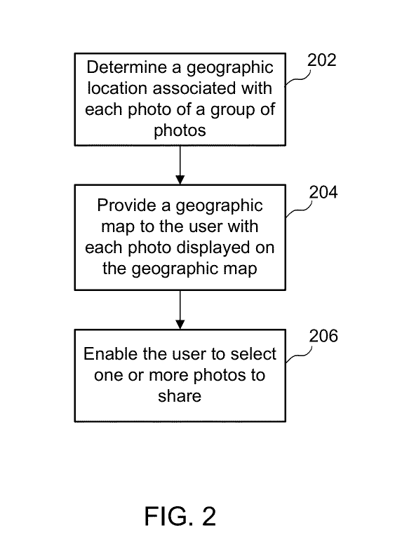

FIG. 2 illustrates an example simplified flow diagram for sharing photos in a social network system, according to one embodiment. Referring to both FIGS. 1 and 2, a method is initiated in block 202, where system 102 determines a geographic location associated with each photo of a group of photos associated with the user. In various embodiments, each geographic location represents a location at which each respective photo was taken.

In some embodiments, to determine one or more geographic locations, system 102 may collect geographic metadata associated with each photo. For example, when accessing the user's photos, system 102 may collect from each photo geo-coordinate data (e.g., exchangeable image file (EXIF) data, etc.), or other geo-coding data or tagging indicia related to a geographic location. System 102 may then determine each geographic location based on the respective geographic metadata.

In various embodiments, system 102 enables users of the social network system to specify and/or consent to the use of particular information. This may include system 102, with user consent, using the user's geographic location or any user-specific and/or identity information during collection of metadata. For example, system 102 may provide users with multiple selections directed to specifying and/or consenting to the use of such information. For example, selections with regard to specifying and/or consenting may be associated with geographic location information associated with individual photos, all photos, individual photo albums, all photo albums, etc. The selections may be implemented in a variety of ways. For example, system 102 may cause buttons or check boxes to be displayed next to various selections. In one embodiment, system 102 enables users of the social network to specify and/or consent to the use of using user-specific information in general.

In various embodiments, system 102 may access the photos from various sources. For example, in some embodiments, system 102 may access the photos by extracting the photos from a media stream such as a photo stream. A photo stream may include photos that the user uploads to the social network system, for example. The photo stream may include photos that are automatically uploaded to the social network system (e.g., via a camera device of the user). In some embodiments, system 102 may enable the user to apply customized upload settings such that newly taken photos from a camera/phone are uploaded to a user's photo stream daily or even shortly after each photo is taken.

In some embodiments, the photo stream may also include photos that the user manually uploads over time. The photos may be uploaded from a group or collection of photos from a variety of storage locations (e.g., mobile phone, memory card, memory stick, the Internet, etc.)

In block 204, system 102 provides a geographic map to the user, where each photo is displayed on the geographic map based on the geographic location where each photo was taken.

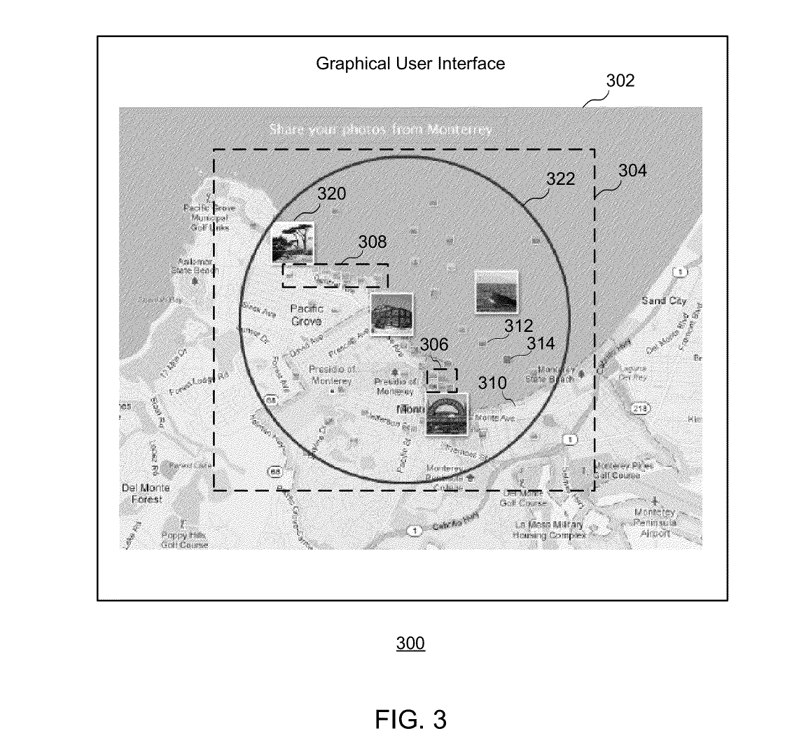

FIG. 3 illustrates an example simplified graphical user interface (GUI) 300 that includes a geographic map 302, according to one embodiment. As shown, in one embodiment, geographic map 302 includes thumbnails of multiple photos 304 based on geographic location. In one embodiment, geographic map 302 may include pushpin icons to indicate more precise geographic locations.

Because people often take photos groups or clusters of multiple photos, geographic map 302 may display photos in clusters where the photos in a particular cluster may be related in time and/or geographic location. For example, the user may take a particular group of photos within a certain time period (e.g., 5 minutes, 10 minutes, etc.). The user may also take a particular group of photos in a similar geographic location (e.g., at the same geographic location, within a 0.1 mile radius, etc.). Geographic map 302 shows such clusters of photos, where photos shown visually in a cluster may be related in time and/or geographic location. Also, photos shown visually in a smaller, crowded cluster (e.g., cluster 306) may be more closely related in time and/or geographic location. Photos shown visually in a larger, spaced out cluster (e.g., cluster 308) may be less related in time and/or geographic location.

While the closeness among photos in a given cluster may vary, and while the specific photos that belong to a given cluster may vary, geographical map 302 provides the user with a quick, intuitive representation of the temporal and spatial relationships among photos. As described in more detail below, this facilitates the user in grouping/selecting which photos to share with particular individuals and/or groups of people.

Such a map view provided by geographic map 302 has numerous benefits compared to alternative grid views of photos, because geographic map 302 intuitively displays photos grouped by their geographic locations where they were taken. This provides an individualized (e.g., customized to the user) geographic map of photos. In one example implementation, if the user takes a trip to particular area (e.g., Monterey Bay), geographic map 302 provides a pictorial story as to the particular locations that the user has visited.

In various embodiments, system 102 enables the user to navigate geographic map 302 in order to vary the view of the photos. For example, system 102 may enable the user to pan geographic map 302, as well as zoom in and out of geographic map 302.

In some embodiments, system 102 enables the user to move or drag photos around geographic map 302. For example, if the global positioning system (GPS) results are not sufficiently precise, system 102 may enable the user can drag one or more photos to different locations on geographic map 302. In some scenarios, where an image capture device (e.g., camera) does not have a GPS, a user may drag or drop one or more photos to different locations on geographic map 302.

In some scenarios, the user may be in one geographic location (e.g., location 310) while taking photos of objects at one or more distant geographic locations (e.g., locations 312 and 314). In such a scenario, in one embodiment, system 102 may by default place photos on geographic map 302 at the location of the user (e.g., location 310, where the camera is located). As such, system 102 may enable the user to drag one or more photos from the default location (e.g., location 310) to the desired geographic locations of the object on the geographic map (e.g., locations 312 and 314). System 102 may enable the user to zoom in as needed in order to reposition a given photo or group of photos to specific locations on geographic map 302.

In one embodiment, system 102 may enable the user to add other metadata to each photo via geographic map 302. For example, in one embodiment, system 102 may enable the user to select a given photo (e.g., by clicking on the thumbnail). In response, system 102 may cause a new window with entry fields to be displayed to the user. System 102 may then receive typed-in information that the user enters into the entry fields. For example, the user may type in a location (e.g., geographic coordinates such as latitude and longitude), or the name of a location (e.g., Monterey Bay Aquarium). In some embodiments, metadata that helps a user quickly identify a photo or annotate a photo may also be added. For example, a star symbol may be added to indicate a favorite photo, or written descriptions or labels may also be added in the metadata field. Accordingly, such embodiments that enable entry of metadata via geographic map 302 provide the user with a quick and convenient process for adding metadata to photos.

In one embodiment, system 102 may enable the user to add other metadata to each photo via the geographic map. For example, system 102 may also enable the user, via the geographic map, to tag a photo with people (e.g., tag with one or more face tags).

While embodiments are described herein in the context of photos, system 102 may also cause other types of media files to be displayed in the geographic map. For example, in the one embodiment, geographic map 302 may also include thumbnail representations of videos, which were taken along with photos.

In block 206, system 102 enables the user to select one or more photos to share based on interaction with the geographic map. System 102 enables the user to interact with geographic map 302 in various ways in order to share the photos with other individuals and/or groups of people. For example, system 102 may enable the user to select photos individually or to select photos by group. If the user selects photos individually, system 102 may enable the user to select a given photo by clicking on the photo. In some embodiments, in response to the user clicking on a photo (e.g., photo 320), system 102 may display the photo more prominently relative to other photos. For example, in some embodiments, system 102 may enlarge the photo such that it stands out. In some embodiments, system 102 may highlight such selected photos. The user may individually select one or more photos for sharing.

If the user selects photos in groups, system 102 may enable the user to select photos based on their proximate geographic location shown on geographic map 302. For example, in some embodiments, system 102 may enable the user to select/highlight a group or cluster of photos by clicking on an area of the map, and by dragging a frame of any given shape around a group of photos. For example, frame 322 shown in FIG. 3 may indicate a group of selected photos for sharing.

In some embodiments, system 102 may suggest a collection or group of photos for the user to share based on geographic data. For example, system 102 may select a group of photos that are geographically clustered together, recommend the group of photos, and enable the user to select the recommended group of photos to share. The sharing may occur with a single click, or drag and drop action. For example, in some embodiments, system 102 may enable the user to drag the group of photos to an icon representing a social network group of people, or vice versa. In some embodiments, system 102 may enable the user to modify the suggested group (e.g., omit one or more photos to be shared). In one embodiment, system 102 may determine the photos that belong to a given cluster based on various factors, or combination of factors. For example, in one embodiment, system 102 may select photos that are within a predetermined radius. In one embodiment, system 102 may select photos based on the density of photos taken within a predetermined radius. In some embodiments, system 102 may suggest multiple groups of photos for sharing, where system 102 enables the user to select each group with a single click, or drag and drop action.

System 102 may also enable the user to indicate one or more other photos to be shared based at least one attribute relative to a first selected photo. For example, system 102 may receive a selection indication from the user to select a given photo. System 102 may enable the user to then issue another selection indication to include all photos taken within a specified zone or of a specified distance radius. Similarly, in some embodiments, system 102 may enable the user to then issue another selection indication to include all photos taken within a predetermined time period from when the first photo was taking (e.g., within 10 minutes, within an hour, within the same day, etc.).

In various embodiments, system 102 may then create one or more photo albums from the selected photos or share the photos directly with others (e.g., via emails and other message, via shared albums, etc.) in response to user commands. In various embodiments, system 102 enables the user to share the photos in various ways. Example embodiments directed to sharing are described in more detail below.

In various embodiments, system 102 enables the user to share photos via geographic map 302 with individuals and/or groups of people. Such groups of people may include, for example, friends, family, and professionals, as well as the general public.

For example, system 102 may enable the user to send the photos via email, posts, and other messages. System 102 may also enable other users of the social network system to access a photo album that contains the selection of photos to be shared. In one embodiment, system 102 may assign a user-selected viewing privilege to each selection of photos to be shared (e.g., to photos individually or to groups of photos). For example, for a given selected photo or group of photos, the user may select individuals or groups of people to have viewing privileges of the selected photos. As indicated above, such groups of people may include, for example, friends, family, and professionals, as well as the general public.

In some embodiments, system 102 may enable the user to elect to have the user's photo stream available to the one or more selected individuals or groups for viewing after being uploaded. The user may select individuals or groups of people to have viewing privileges of the selected photos in the user's photo stream.

As indicated above, the selected photos may be grouped into one or more albums. In some embodiments, system 102 may enable the user to elect to have the user's one or more photo albums available to the one or more selected individuals or groups for viewing. The user may select individuals or groups of people to have viewing privileges of the created albums.

In some embodiments, system 102 enables the user to customize qualifications or criteria for sharing photos. In some embodiments, system 102 enables the user to select photos to share based at least in part on one or more attributes, such as their respective geographic locations. For example, system 102 may enable the user to select photos to share based on a combination of particular tags, number of people, dates when photos were taken, resolution, photo quality, interestingness, etc., associated with each photo. In some embodiments, in combination with other selection methods described herein (e.g., the user creating a selection frame around a group), system 102 may filter out photos that do not meet user-specified criteria. As such, system 102 may exclude such photos from sharing. In some embodiments, system 102 may highlight photos that do meet user-specified criteria, where the user may confirm whether to include such highlighted photos to be shared.

In some embodiments, system 102 may rank photos based on one or more attributes such as those described herein. System 102 may indicate the top-ranked photos (e.g., by highlighting the top-ranked photos in geographic map 302, and in some implementations recommend such photos to be shared.

In some embodiments, after the user selects one or more photos to share, system 102 may enable the user to drag icons that represent individuals or icons that represent groups over one or more selected photos on geographic map 302. This may be one of multiple ways that the user may indicate which individual(s) or group(s) to share the selected photos.

Although the steps, operations, or computations may be presented in a specific order, the order may be changed in particular embodiments. Other orderings of the steps are possible, depending on the particular implementation. In some particular embodiments, multiple steps shown as sequential in this specification may be performed at the same time.

While system 102 is described as performing the steps as described in the embodiments herein, any suitable component or combination of components of system 102 or any suitable processor or processors associated with system 102 may perform the steps described.

Embodiments described herein provide various benefits. For example, embodiments described herein also increase overall engagement among users in a social networking environment by facilitating the user in sharing photos that are uploaded to the social network system with other users of the social network system. Embodiments enable the user to quickly and conveniently share photos or groups of photos via such interactions with the geographic map, which increases the percentage of photos that are shared.

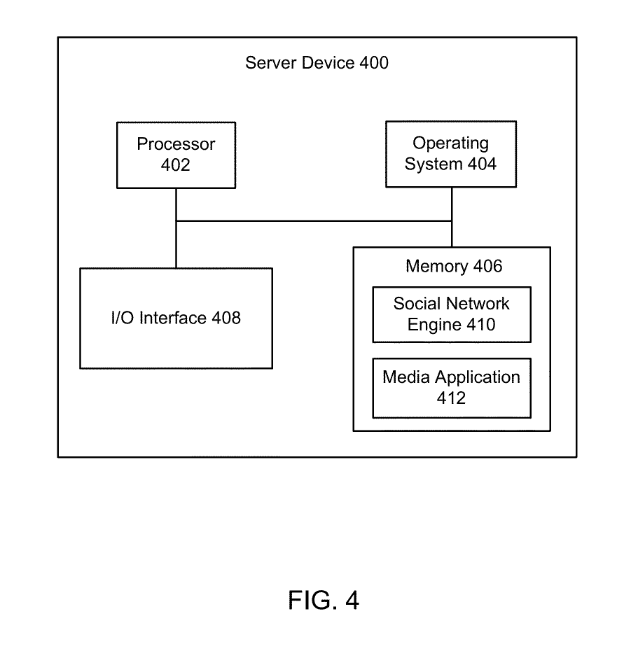

FIG. 4 illustrates a block diagram of an example server device 400, which may be used to implement the embodiments described herein. For example, server device 400 may be used to implement server device 104 of FIG. 1, as well as to perform the method embodiments described herein. In one embodiment, server device 400 includes a processor 402, an operating system 404, a memory 406, and an input/output (I/O) interface 408. Server device 400 also includes a social network engine 410 and a media application 412, which may be stored in memory 406 or on any other suitable storage location or computer-readable medium. Media application 412 provides instructions that enable processor 402 to perform the functions described herein and other functions.

For ease of illustration, FIG. 4 shows one block for each of processor 402, operating system 404, memory 406, I/O interface 408, social network engine 410, and media application 412. These blocks 402, 404, 406, 408, 410, and 412 may represent multiple processors, operating systems, memories, I/O interfaces, social network engines, and media applications. In other embodiments, server device 400 may not have all of the components shown and/or may have other elements including other types of elements instead of, or in addition to, those shown herein.

Although the description has been described with respect to particular embodiments thereof, these particular embodiments are merely illustrative, and not restrictive. Concepts illustrated in the examples may be applied to other examples and embodiments.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of particular embodiments. Different programming techniques may be employed such as procedural or object-oriented. The routines may execute on a single processing device or multiple processors. Although the steps, operations, or computations may be presented in a specific order, the order may be changed in different particular embodiments. In some particular embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

1. A method comprising:
accessing a plurality of photos associated with a user;
determining a geographic location associated with each photo of the plurality of photos, wherein each geographic location represents a location at which each respective photo was taken, and wherein the determining of each geographic location includes:
collecting geographic metadata associated with each photo; and
determining each geographic location based on the respective geographic metadata;
providing a geographic map to the user, wherein each photo is displayed on the geographic map based on the geographic location of each photo;
enabling the user to select one or more photos to share based on interaction with the geographic map; and
assigning a user-selected viewing privilege to the selected one or more photos.

2. A method comprising:
determining a geographic location associated with each photo of a plurality of photos associated with a user;
providing a geographic map to the user, wherein each photo is displayed on the geographic map based on the geographic location of each photo; and
enabling the user to select one or more photos to share based on interaction with the geographic map.

3. The method of claim 2, further comprising accessing a digital media stream, wherein the digital media stream includes the plurality of photos.

4. The method of claim 2, further comprising collecting geographic metadata associated with each photo.

5. The method of claim 2, further comprising:
collecting geographic metadata associated with each photo; and
determining each geographic location based on the respective geographic metadata.

6. The method of claim 2, wherein each geographic location represents a location at which each respective photo was taken.

7. The method of claim 2, further comprising enabling the user to select the photos to share based on their respective geographic locations.

8. The method of claim 2, wherein the enabling of the user to select photos comprises enabling the user to select one or more photos displayed on the geographic map.

9. The method of claim 2, wherein the enabling of the user to select photos comprises:
enabling the user to select at least one photo displayed on the geographic map; and
enabling the user to indicate at least a second photo to be shared based on at least one attribute relative to the at least one photo.

10. The method of claim 2, further comprising enabling the user to select photos to share based at least in part on one or more attributes.

11. The method of claim 2, further comprising assigning a user-selected viewing privilege to the selected one or more photos.

12. A system comprising:
one or more processors; and
logic encoded in one or more tangible media for execution by the one or more processors and when executed operable to perform operations comprising:
determining a geographic location associated with each photo of a plurality of photos associated with a user;
providing a geographic map to the user, wherein each photo is displayed on the geographic map based on the geographic location of each photo; and
enabling the user to select one or more photos to share based on interaction with the geographic map.

13. The system of claim 12, wherein the logic when executed is further operable to perform operations comprising accessing a digital media stream, and wherein the digital media stream includes the plurality of photos.

14. The system of claim 12, wherein the logic when executed is further operable to perform operations comprising collecting geographic metadata associated with each photo.

15. The system of claim 12, wherein the logic when executed is further operable to perform operations comprising:
collecting geographic metadata associated with each photo; and
determining each geographic location based on the respective geographic metadata.

16. The system of claim 12, wherein each geographic location represents a location at which each respective photo was taken.

17. The system of claim 12, wherein the logic when executed is further operable to perform operations comprising enabling the user to select the photos to share based on their respective geographic locations.

18. The system of claim 12, wherein the logic when executed is further operable to perform operations comprising enabling the user to select one or more photos displayed on the geographic map.

19. The system of claim 12, wherein the logic when executed is further operable to perform operations comprising:
enabling the user to select at least one photo displayed on the geographic map; and
enabling the user to indicate at least a second photo to be shared based on at least one attribute relative to the at least one photo.

20. The system of claim 12, wherein the logic when executed is further operable to perform operations comprising enabling the user to select photos to share based at least in part on one or more attributes.
